(19) United States
(12) Patent Application Publication
(10) Pub. No.: US 2026/0072914 A1
(43) Pub. Date: Mar. 12, 2026

(54) SYSTEM AND METHOD FOR DYNAMICALLY INDUCING OUTPUTS VIA COLLABORATIVE INTELLIGENT AGENTS

(71) Applicant: Florida Gulf Coast University Board of Trustees, Fort Myers, FL (US)

(72) Inventor: Fernando Garcia Gonzalez, Fort Myers Beach, FL (US)

(21) Appl. No.: 19/391,189

(22) Filed: Nov. 17, 2025

Related U.S. Application Data
(63) Continuation of application No. PCT/US2024/029713, filed on May 16, 2024.
(60) Provisional application No. 63/502,503, filed on May 16, 2023.

(51) Int. Cl. G06F 16/2453; G06F 16/25

(52) U.S. Cl. CPC G06F 16/24542; G06F 16/258

(57) ABSTRACT

Described herein relates to a system and method that supports the creation and execution of collaborative intelligent agents to process machine-readable data into dynamic and/or related outputs. As such, the collaborative intelligent agent system and/or methods thereof may include a compiler to generate an executable expression tree, an executor to manage intelligent agent execution using the expression tree, and/or a processor to manage intelligent agent collaboration during execution. Additionally, using machine-readable inputs, the collaborative intelligent agent system and/or methods thereof may automatically execute the collaborative intelligent agents to dynamically induce outputs, without requiring user interaction. As such, the collaborative intelligent agent system and/or methods thereof may also be configured to realize the second pillar of the Semantic Web and/or may improve upon HTML or machine-readable code only, providing a mechanism to automatically produce dynamic outputs based on input data.

### CROSS-REFERENCE TO RELATED APPLICATIONS

This Nonprovisional Patent Application is a continuation of International PCT Application No. PCT/US2024/029713 entitled, “SYSTEM AND METHOD FOR DYNAMICALLY INDUCING OUTPUTS VIA COLLABORATIVE INTELLIGENT AGENTS” filed May 16, 2024, which claims the benefit of and priority to U.S. Provisional Patent Application No. 63/502,503 entitled “SYSTEM AND METHOD FOR DYNAMICALLY INDUCING OUTPUTS VIA COLLABORATIVE INTELLIGENT AGENTS” filed May 16, 2023 by the same inventor, all of which are incorporated herein by reference, in its entirety, for all purposes.

### BACKGROUND OF THE INVENTION

### 1. Field of the Invention

This invention relates, generally, to intelligent agents that automatically induce outputs in a collaborative manner. More specifically, it relates to a system and method for dynamically inducing outputs via collaborative intelligent agents, such that machine readable data is used by the intelligent agents to induce outputs.

### 2. Brief Description of the Prior Art

Typically, webpages utilize hypertext markup language (HTML) to code text, images, videos, layout, and other visual renderings for the pages. Often, web browsers or other rendering tools are used to present a visual page that is human-readable based on the underlying HTML coding, such that the information stored in HTML format is viewable and interactable by humans encountering the webpages. However, while HTML provides a way of rendering background coding to a viewer, the rendering tool (such as a web browser) simply displays a readable version of the HTML coding in a particular layout; there are no inherent links between sections of the HTML code, thereby limiting the usefulness of the HTML beyond the simple rendering of information.

The Semantic Web is an extension of the World Wide Web which attempts to overcome the deficiencies of HTML by making webpage coding contents machine-readable for further processing, extending beyond the capabilities of HTML. To date, the first pillar of the Semantic Web has been realized—that of representing and storing data in a machine-readable format. An example of such a realization is Resource Description Framework (RDF) technology; another example is Web Ontology Language (OWL). In both RDF and OWL, metadata is represented through embedded semantic relationships between data entries and categories. However, to date, the second pillar of the Semantic Web-processing the machine-readable data in a meaningful way—has not been realized in the prior art.

Accordingly, what is needed is an automated and/or dynamic system and/or method for inducing outputs via intelligent agents, usable in combination with the HTML coding, including but not limited to the Semantic Web. However, in view of the art considered as a whole at the time the present invention was made, it was not obvious to those of ordinary skill in the field of this invention how the shortcomings of the prior art could be overcome.

### SUMMARY OF THE INVENTION

The long-standing but heretofore unfulfilled need, stated above, is now met by a novel and non-obvious invention disclosed and claimed herein. In an aspect, the present disclosure pertains to a method of automatically, and/or dynamically inducing outputs via a plurality of intelligent agents. In an embodiment, the method may comprise the following steps: (a) searching, via a first intelligent agent, a first set of prerequisite thresholds for a match of an updated data point; (b) based on a determination of the match of the updated data point, executing the first intelligent agent to produce a first output; (c) searching, via a second intelligent agent, a second set of prerequisite thresholds for a match of the first output received from the first intelligent agent and/or a match of at least one alternative output received from at least one alternative intelligent agent; and (d) based on a determination of the match of the first output and/or the match of the at least one alternative output inducing an execution of the second intelligent agent to produce a second output.

In some embodiments, the first intelligent agent may have an output that is an input for the second intelligent agent. As such, the first and/or second intelligent agents may be independent from each other, such that each of the first and/or second intelligent agents may include a set of prerequisite thresholds.

In some embodiments, the method may also further comprise the step of, translating an amount of data into a machine-readable format. In these other embodiments, the method may further comprise the step of, compiling the machine-readable data and/or generating relationships between subjects, predicates, and/or objects of the machine-readable data. Additionally, the method may further comprise the steps of, generating the first intelligent agent and/or the second intelligent agent and/or receiving an input of the updated data point.

Additionally, in some embodiments, the method may further comprise the step of, preserving, via a token system communicatively coupled to the first intelligent agent and/or the second intelligent agent, an order of the first agent, the second agent, and/or between the first output and the second output. In this manner, the step of preserving the order between the first output and the second output may further include the step of, generating, via the token system, an input token and/or an output token, such that the input token and/or the output token may be analogous to labels representing an instruction address of the first agent and/or the second agent. In this manner, when the input token is available, the output token may then indicate a next output to execute.

In addition, in some embodiments, the method may further comprising the step of, interlinking at least one of a plurality of triples with the first intelligent agent and/or the second intelligent agent, such that at least one of the plurality of triples may be considered a variable. In these other embodiments, when at least one additional triple of the plurality of triples is interlinked with the first intelligent agent and/or the second intelligent agent, the first intelligent agent and/or the second intelligent agent may be configured to execute at least one of a plurality of programs that include at least one triple of the plurality of tiples as an input. As such, the execution of at least one of the plurality of programs that include at least one triple of the plurality of triples may comprise a run time proportional to O(log (n)) per program match, such that the first intelligent agent and/or the second intelligent agent may be configured to search for any additional executable programs at the same optimal time of O(log (n)).

Moreover, another aspect of the present disclosure pertains to an automatic and/or dynamic system for inducing outputs via intelligent agents. In an embodiment, the system may comprise the following: (a) at least one processor; and (b) a non-transitory computer-readable medium operably coupled to the processor, the computer-readable medium having computer-readable instructions stored thereon that, when executed by the at least one processor, cause the automatic and/or dynamic system to induce a plurality of outputs via a plurality of intelligent agents by executing instructions comprising: (i) searching, via a first intelligent agent, a first set of prerequisite thresholds for a match of an updated data point; (ii) based on a determination of the match of the updated data point, executing the first intelligent agent to produce a first output; (iii) searching, via a second intelligent agent, a second set of prerequisite thresholds for a match of the first output received from the first intelligent agent and/or a match of at least one alternative output received from at least one alternative intelligent agent; and (iv) based on a determination of the match of the first output and/or the match of at least one alternative output, inducing an execution of the second intelligent agent to produce a second output.

In some embodiments, the executable instructions may further comprise the step of, translating an amount of data into a machine-readable format. In this manner, in these other embodiments, the executable instructions may further comprise the step of, compiling the machine-readable data and/or generating relationships between subjects, predicates, and/or objects of the machine-readable data. In these other embodiments, the executable instructions may also comprise the steps of, generating a first intelligent agent and/or a second intelligent agent and/or receiving an input of the updated data point.

In some embodiments, the executable instructions may further comprise the step of, preserving, via a token system communicatively coupled to the first intelligent agent and/or the second intelligent agent, an order of the first agent, the second agent, and/or between the first output and the second output. In this manner, the step of preserving the order of the first agent, the second agent, and/or between the first output and the second output of the executable instructions may further comprise the step of, generating, via the token system, an input token and/or an output token, in which the input token and/or the output token may be analogous to labels representing an instruction address of the first agent and/or the second agent. As such, when the input token is available, the output token may then indicate a next output to execute.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not restrictive.

The invention accordingly comprises the features of construction, combination of elements, and arrangement of parts that will be exemplified in the disclosure set forth hereinafter and the scope of the invention will be indicated in the claims.

### BRIEF DESCRIPTION OF THE DRAWINGS

For a fuller understanding of the invention, reference should be made to the following detailed description, taken in connection with the accompanying drawings, in which:

FIG. 1 is a schematic overview of an intelligent agent in combination with a triplestore, according to an embodiment of the present disclosure.

FIG. 2 is a schematic overview depicting a set of triples and a corresponding expression tree for an intelligent agent system, according to an embodiment of the present disclosure.

FIG. 3 is a schematic overview depicting an expression tree for an assignment system, according to an embodiment of the present disclosure.

FIG. 4 is a schematic overview depicting an initial reference knowledge graph, according to an embodiment of the present disclosure.

FIG. 5 is a schematic overview depicting the knowledge graph of FIG. 4, including a first intelligence agent inducement, according to an embodiment of the present disclosure.

FIG. 6 is a schematic overview depicting the knowledge graph of FIG. 5, including a second intelligent agent inducement, according to an embodiment of the present disclosure.

FIG. 7 is a set of execution instructions for one or more intelligent agents, according to an embodiment of the present disclosure.

### DETAILED DESCRIPTION OF THE INVENTION

In the following detailed description of the preferred embodiments, reference is made to the accompanying drawings, which form a part thereof, and within which are shown by way of illustration specific embodiments by which the invention may be practiced. It is to be understood that one skilled in the art will recognize that other embodiments may be utilized, and it will be apparent to one skilled in the art that structural changes may be made without departing from the scope of the invention.

As such, elements/components shown in diagrams are illustrative of exemplary embodiments of the disclosure and are meant to avoid obscuring the disclosure. Any headings, used herein, are for organizational purposes only and shall not be used to limit the scope of the description or the claims.

Furthermore, the use of certain terms in various places in the specification, described herein, are for illustration and should not be construed as limiting. For example, any reference to an element herein using a designation such as “first,” “second,” and so forth does not limit the quantity or order of those elements, unless such limitation is explicitly stated. Rather, these designations may be used herein as a convenient method of distinguishing between two or more elements or instances of an element. Therefore, a reference to first and/or second elements does not mean that only two elements may be employed there or that the first element must precede the second element in some manner. Also, unless stated otherwise a set of elements may comprise one or more elements

Reference in the specification to “one embodiment,” “preferred embodiment,” “an embodiment,” or “embodiments” means that a particular feature, structure, characteristic, or function described in connection with the embodiment is included in at least one embodiment of the disclosure and may be in more than one embodiment. The appearances of the phrases “in one embodiment,” “in an embodiment,” “in embodiments,” “in alternative embodiments,” “in an alternative embodiment,” or “in some embodiments” in various places in the specification are not necessarily all referring to the same embodiment or embodiments. The terms “include,” “including,” “comprise,” and “comprising” shall be understood to be open terms and any lists that follow are examples and not meant to be limited to the listed items.

Referring in general to the following description and accompanying drawings, various embodiments of the present disclosure are illustrated to show its structure and method of operation. Common elements of the illustrated embodiments may be designated with similar reference numerals.

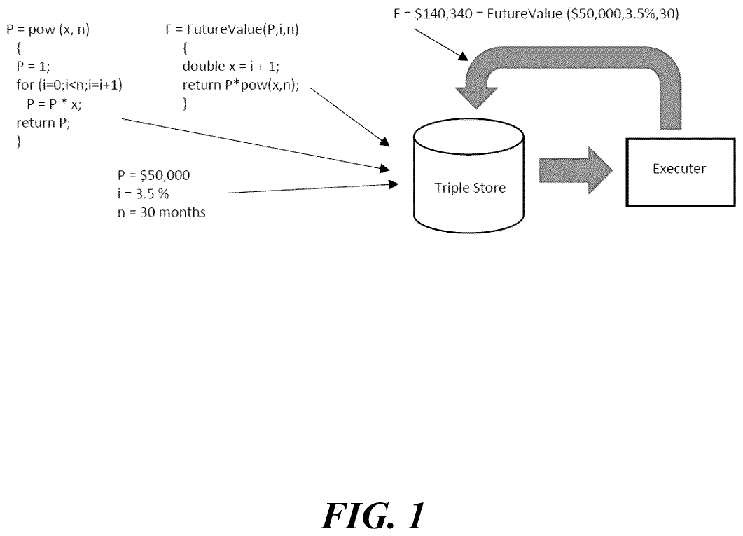

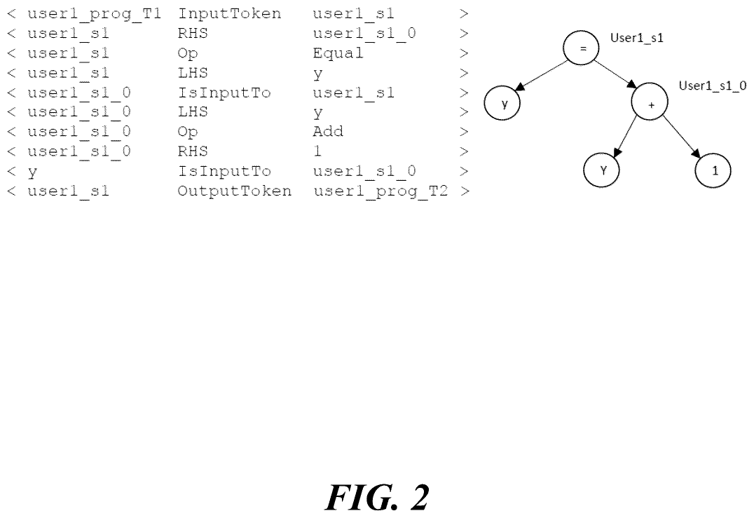

Accordingly, the relevant descriptions of such features apply equally to the features and related components among all the drawings. For example, any suitable combination of the features, and variations of the same, described with components illustrated in FIG. 1, can be employed with the components of FIG. 2, and vice versa. This pattern of disclosure applies equally to further embodiments depicted in subsequent figures and described hereinafter. It should be understood that the figures presented are not meant to be illustrative of actual views of any particular portion of the actual structure or method but are merely idealized representations employed to more clearly and fully depict the present invention defined by the claims below.

### Definitions

As used in this specification and the appended claims, the singular forms “a,” “an,” and “the” include plural referents unless the content clearly dictates otherwise. As used in this specification and the appended claims, the term “or” is generally employed in its sense including “and/or” unless the context clearly dictates otherwise.

In the following description, for the purposes of explanation, numerous specific details are set forth in order to provide a thorough understanding of embodiments of the present technology. It will be apparent, however, to one skilled in the art that embodiments of the present technology may be practiced without some of these specific details.

The techniques introduced here can be embodied as special-purpose hardware (e.g. circuitry), as programmable circuitry appropriately programmed with software and/or firmware, or as a combination of special-purpose and programmable circuitry. Hence, embodiments may include a computer-readable medium having stored thereon instructions which may be used to program a computer (or other electronic devices) to perform a process.

The computer readable medium described in the claims below may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program PIN embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program PIN embodied on a computer readable medium may be transmitted using any appropriate medium, including but not limited to wireless, wire-line, optical fiber cable, radio frequency, etc., or any suitable combination of the foregoing. Computer program PIN for carrying out operations for aspects of the present invention may be written in any combination of one or more programming languages, including an object oriented programming language such as Java, C#, C++, Python, MATLAB, and/or the like and conventional procedural programming languages, such as the “C” programming language or similar programming languages.

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computing device, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

As used herein, the term “communicatively coupled” refers to any coupling mechanism configured to exchange information (e.g., at least one electrical signal) using methods and devices known in the art. Non-limiting examples of communicatively coupling may include Wi-Fi, Bluetooth, wired connections, wireless connection, quantum, and/or magnets. For ease of reference, the exemplary embodiment described herein refers to Wi-Fi and/or Bluetooth, but this description should not be interpreted as exclusionary of other electrical coupling mechanisms.

As used herein, the term “end-user” refers to any operator of a software known in the art as opposed to a developer and/or author who may modify the underlying source code of the software.

As used herein, for security purposes, the term “authentication” refers to identifying the particular user while the term “authorization” refers to defining what procedures and/or functions that user is permitted to execute.

As used herein, the terms “about,” “approximately,” or “roughly” refer to being within an acceptable error range (i.e., tolerance) for the particular value as determined by one of ordinary skill in the art, which will depend in part on how the value is measured or determined (e.g., the limitations of a measurement system) (e.g., the degree of precision required for a particular purpose, such as dynamically inducing outputs via collaborative intelligent agents, such that machine readable data is used by the intelligent agents to induce outputs). As used herein, “about,” “approximately,” or “roughly” refer to within +25% of the numerical.

All numerical designations, including ranges, are approximations which are varied up or down by increments of 1.0, 0.1, 0.01 or 0.001 as appropriate. It is to be understood, even if it is not always explicitly stated, that all numerical designations are preceded by the term “about”. It is also to be understood, even if it is not always explicitly stated, that the compounds and structures described herein are merely exemplary and that equivalents of such are known in the art and can be substituted for the compounds and structures explicitly stated herein.

Wherever the term “at least,” “greater than,” or “greater than or equal to” precedes the first numerical value in a series of two or more numerical values, the term “at least,” “greater than” or “greater than or equal to” applies to each of the numerical values in that series of numerical values. For example, greater than or equal to 1, 2, or 3 is equivalent to greater than or equal to 1, greater than or equal to 2, or greater than or equal to 3.

Wherever the term “no more than,” “less than,” or “less than or equal to” precedes the first numerical value in a series of two or more numerical values, the term “no more than,” “less than” or “less than or equal to” applies to each of the numerical values in that series of numerical values. For example, less than or equal to 1, 2, or 3 is equivalent to less than or equal to 1, less than or equal to 2, or less than or equal to 3.

### Collaborative Intelligent Agents System and Method

The present invention includes a system and method that supports the creation and/or execution of collaborative intelligent agents to process machine-readable data into dynamic and/or related outputs. In an embodiment, the system (hereinafter “collaborative intelligent agent system”) and/or method may comprise the following: (1) at least one compiler configured to generate an executable expression tree; (2) at least one executor configured to manage intelligent agent execution using the expression tree; and/or (3) at least one processor configured to manage intelligent agent collaboration during execution. Using machine-readable inputs, in this embodiment, the collaborative intelligent agent system and/or methods thereof automatically execute the collaborative intelligent agents to dynamically induce outputs, without requiring user interaction. As such, the collaborative intelligent agent system may realize the second pillar of the Semantic Web and/or may be configured to improve upon HTML and/or machine-readable code only, providing a mechanism to automatically produce dynamic outputs based on input data, in real-time. The automated collaborative intelligent agent system and/or methods thereof for inducing outputs via intelligent agents will be described in greater detail in the sections below.

In an embodiment, the collaborative intelligent agent system may be configured to receive and/or generates at least one relationship between an input data category and at least one output data category, with the input data, output data, and/or relationships between input data and output data stored within a storage medium accessible by a computing device comprising at least one processor configured to execute the collaborative intelligent agent system and/or methods thereof. In this embodiment, the at least one processor of the computing device may be communicatively coupled to the at least one compiler, the at least one executor and/or the at least one processor configured to manage intelligent agent collaboration during execution Additionally, in this embodiment, the data may be stored in a triples format including a subject, predicate, and/or object, and/or, in this embodiment, each triples relationship may be stored within a triplestore accessible by the collaborative intelligent agent system.

Additionally, in an embodiment, the collaborative intelligent agent system may receive and/or generate the relationships between inputs and outputs, such that the collaborative intelligent agent system may be configured to receive and/or generate at least one of a plurality of intelligent agent, each including at least one of a plurality of the input/output relationships. As a result, the collaborative intelligent agent system and/or methods thereof may only be executed to completion when each parameter for each of the plurality of input/output relationship (or triple) is met. Accordingly, in this embodiment, if only one parameter within an intelligent agent is not met, then the collaborative intelligent agent system and/or methods thereof may not be executed to completion, via the at least one processor of the computing device.

Moreover, in an embodiment, since the intelligent agents may be collaborative in nature, the collaborative intelligent agent system and/or methods thereof may include the inducing of at least one alternative intelligent agent based on the dynamically produced outputs of a first intelligent agent, so long as the output and/or the execution of the first intelligent agent may be a parameter of the at least one alternative intelligent agent. For example, in some embodiments, the updating of one input data point may automatically result in the generation of at least one of a plurality of different queries in at least one of the plurality of intelligent agents, in real-time. In this manner, the collaborative intelligent agent system and/or methods thereof may then be configured to automatically search through at least one of the plurality intelligent agents for parameter matches, with execution taking place only if all of the plurality of parameters match, and/or disconnection taking place if at least one of the plurality of parameters does not match.

Importantly, in an embodiment, each intelligent agent may be discrete and/or contents (e.g., including input/output relationships, parameters, and any other stored data) of each intelligent agent may be distinct and/or confidential with respect to the other intelligent agents. As such, multiple stakeholders may be able to interact with a set of parameters without awareness of the intelligent agents of each other. Moreover, in this embodiment, each intelligent agent may also be limited to deliver an output based on received input data without storing the input and/or output in non-transitory memory associated with the at least one processor of the computing device. Accordingly, the input and/or output may then be stored outside of each intelligent agent, such that the intelligent agents may be isolated from stored data outside of utilizing the stored data to generate an output.

FIG. 1 depicts a schematic overview of an intelligent agent, according to an embodiment of the present disclosure. As such, as shown in FIG. 1, in this embodiment, at least three items may be disposed in a triplestore. For example, in some embodiments, the at least three items disposed in the triplestore may comprise two programs (FutureValue( ) and pow( )) and/or one data set (P, i, and n).

In this manner, as shown in FIG. 1, in an embodiment, the intelligent agent may be configured to search for at least three items which may be combined to execute the FutureValue(P,i,n) program, calling the pow (x,n) program and/or executing the program using the input data (e.g., such as P=about $50,000, i=about 3.5%, and n=about 30 months) to compute an output (e.g., such as F=about $143,430). In addition, the output may then be added to the triplestore, such that the output may be recorded within the non-transitory memory associated with the at least one processor of the collaborative intelligent agent system and/or may be implemented by the collaborative intelligent agent system and/or methods thereof in future executions.

In an embodiment, the triplestore may be maintained in a maximal inferred state. For example, in some embodiments (See FIG. 1), if the interest rate, i, and/or the number of payments, n, are known, then the pow (i+1, n) may be computed and/or stored in the triplestore. Next, as soon as the principle, P, is added to the triplestore, the intelligent agent of the collaborative intelligent agent system may be configured to complete the computation and/or infer the future value. In some embodiments, the collaborative intelligent agent system may implement at least one alternative method to represent the program by using triples to include a URL to a text file which may contain the high-level program. In this manner, in these other embodiments, this program may then be parsed and/or executed when all of its inputs are available.

Additionally, in an embodiment, the representation using triples of the collaborative intelligent agent system may result in a fractal architecture, such that each statement in the program may be an independent program tied together by tokens. As such, the fractal architecture may allow for parts of a program to be executed before its full set of inputs are available, such that the programs may be executed over time as inputs become available. Moreover, the fractal architecture implemented by the collaborative intelligent agent system may also increase the efficiency of the agent intelligence. With the fractal architecture, the number of searches needed to find matches between the added data and the agents that run on the fractal architecture of the collaborative intelligent agent system may be reduced by a factor proportional to the number of inputs for the agent.

In an embodiment, using the text file method, all inputs may be searched for availability to see if the agent can run, which may use extensive computational resources, including when the agent cannot run. Accordingly, using the fractal architecture, all execution using a new input may be performed until it needs an inexistent input at which time it stops execution. As such, the collaborative intelligence agent system and/or methods thereof may be configured to determine when to stop trying to execute with only one failed search. Finally, in this embodiment, with the fractal architecture, there may be no internal state data, such as a system stack and/or temporary variables, which may need to be maintained during execution. Therefore, in some embodiments, execution on at least one server may stop and/or resume on a different server with no overhead, allowing the execution to be distributed among different servers at different times.

To ensure that the collaborative intelligent agent system and/or methods thereof include ordered executions, in an embodiment, intermediate variables may be assigned between binary operations of each triple, since triples do not inherently include an order between each component, with order being preserved by using the intermediate variables. For example, in some embodiments, the statement (x=y+z−2) may be represented as (x1=z−2), (x2=y+x1), and (x=x2). As such, regardless of the statement order, x1 may be computed before x2 since x1 may be an input to x2; similarly, x2 may be computed before x. Similarly, the at least one processor of the collaborative intelligent agent system and/or methods thereof may integrate and/or may be communicatively coupled to a system of tokens, such that the collaborative intelligent agent system and/or methods thereof may use the system of tokens to preserve order between statements, with the tokens being analogous to labels representing instruction addresses in machine code. In this manner, each statement may also include an input token and/or an output token, such that statement may be executed when the input token is available, and/or the output token may indicate the next statement to execute. Moreover, in this embodiment, the intermediate variables may also be used to dictate order within a statement and/or form the expression tree which represents the equation. Each subtree within the expression tree may also be a subprogram in which all triples related to a subprogram may comprise a unique subject which may be an extension of the expression tree's subject. As such, the triples may be tied together by the subjects.

In addition, in an embodiment, the collaborative intelligent agent system and/or methods thereof may be such that inducement may occur in a top-down manner (e.g., in which an added triple completes a set of inputs to induce the rest of the program), and/or in a bottom-up manner (e.g., in which an added triple allows for processing while moving up the expression tree), with each triple being added within a sequential block. For each sequential block, in this embodiment, a component of the block may be identified and/or executed when available, with the entire block being executed once all block components are available. In this manner, each sequential block may be executed in order once all inputs are available for block in a top-down manner within each block, and/or in either a top-down and/or bottom-up manner between sequential blocks.

For example, FIG. 2 depicts the triples representing the statement T1: y=y+1: T2, and/or an expression tree for the statement y=y+1, where T1 may represent the input token and/or T2 may represent the output token, according to an embodiment of the present disclosure. In some embodiments (See FIG. 2), the token may be required to execute the statement is user1_prog_T1; the intermediate variables may be user1_s1 (e.g., the subject representing the whole statement) and/or user1_s1_0 (e.g., the subject representing the y+1 portion of the statement). The IsInputTo predicate may also be configured to indicate that the “+” term may be executed before the “=” term; similarly, the variable user1_s1_0 may be computed prior to computing user1_s1, since user1_s1_0 may be an input to user1_s1. In this embodiment, the IsInputTo triples may hold the portions of the assignment together. To represent an actual operation (e.g., such as y+1), at least three triples (e.g., LHS which determines which variable to move into the accumulator; Op, which determines the operator—such as Add, Subtract, and/or Multiply—to reduce search engine resources; and RHS, which determines the other operand) may be used. Whenever a LHS and/or RHS triple may be added to the database, an IsInverseOf triple may be inferred and/or added as a result, creating reverse links for the expression tree.

In addition, in an embodiment, the execution of a subtree may also comprise first searching for the LHS triple which may return the name of the first operand. If this is not a value, the collaborative intelligent agent system and/or methods thereof may be configured to search for that at least one portion of that variable. If the system finds an approximate value for the variable, the collaborative intelligent agent system and/or methods thereof may continue executing that subtree; otherwise collaborative intelligent agent system and/or methods thereof may execute that subtree recursively. Additionally, when the variable returns, the collaborative intelligent agent system and/or methods thereof may search for the operator triple, which may return the operator. Next, the collaborative intelligent agent system and/or methods thereof may then search for the RHS and/or True or False as the other operand. In this embodiment, if it is a variable, then the collaborative intelligent agent system and/or methods thereof may search for that variable. Once the system has the two operands and the operator, the collaborative intelligent agent system and/or methods thereof may be configured to perform the computation and/or outputs a triple indicating the value of the subtree variable.

In an embodiment, instead of executing in a top-down manner, at least one of the plurality of intelligent agents of the collaborative intelligent agent system may be executed in a non-sequential order, such that at least one new agent may be executed and/or the execution of at least one alternative agent may be induced within the expression tree. Moreover, in this embodiment, the collaborative intelligent agent system and/or methods thereof may not execute the entire program if the complete set of inputs is not available. In this manner, the intermediate variables may also indicate the state of execution for the program.

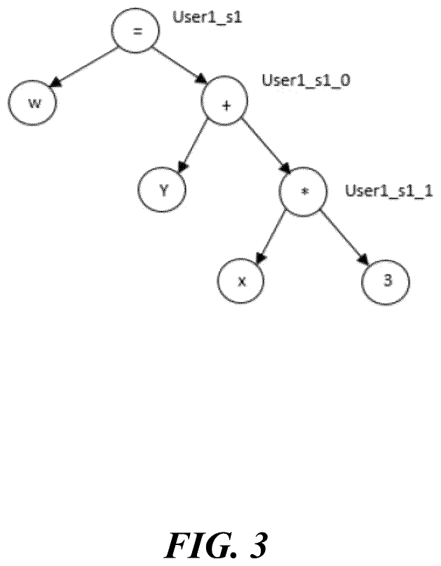

FIG. 3 depicts the expression tree for the statement w=y+x*3 implemented within the collaborative intelligent agent system and/or methods thereof, according to an embodiment of the present disclosure. In this embodiment, each root of the tree may receive an assigned intermediate variable from the compiler of the collaborative intelligent agent system. As such, if the statement is being executed based on receiving the current token, then the expression tree may be executed from the top of the subtree representing the statement. For example, in some embodiments, the variable user1_s1 may be sent to the executor, and/or the collaborative intelligent agent system and/or methods thereof may be configured to search for the variable user1_s1_0. If found, the collaborative intelligent agent system and/or methods thereof may be configured to execute the respective subtree, producing the triple indicating that w has the computed value. However, in these other embodiments, if the variable user1_s1_0 is not found, then the executor of the collaborative intelligent system may be configured to recursively call to execute user1_s1_0. In this manner, when it returns, the collaborative intelligent agent system and/or methods thereof may be configured to search for the variable user1_s1_0 again; if found, the subtree may be executed, and/or if the variable is not found, the execution of the program may be disconnected.

Moreover, in an embodiment, if the statement is being executed because a triple is received indicated the value for x, the expression tree may be executed from the branch including the x triple. The collaborative intelligent agent system and/or methods thereof may then search for the variable for which x may be an input, and/or the collaborative intelligent agent system and/or methods thereof may identify and/or execute the user1_s1_1 subtree. Additionally, in this embodiment, the collaborative intelligent agent system and/or methods thereof may then be configured to search for the variable for which user1_s1_1 may be an input, identifying and/or executing the user1_s1_0 subtree. If the execution succeeds (i.e., if y exists), the collaborative intelligent agent system and/or methods thereof may next search and/or execute the parent user1_s1 subtree. Finally, the statement outputs the next token and/or sequential execution of the program continues. However, in this same manner, if y does not exist, the collaborative intelligent agent system and/or methods thereof may be configured to disconnect after attempting to executing user1_s1_0, until receiving a value for y.

As such, in an embodiment, as used within the collaborative intelligent agent system and/or methods thereof, triples may be considered as variables, as opposed to simply being considered data (e.g., in a database) and/or knowledge (e.g., in a knowledge graph), such that the triples may be linked to intelligent agents. For example, in some embodiments, a “Value” triple may be in the triple (e.g., <User5_Property_4 Value $430,000>), such that the “Value” triple may be linked to a variable (e.g., such as “double value” for an intelligent agent (e.g., such as double_value[i] “Value” {“IsA”, “Property”}). In addition, in these other embodiments, the input variable may be an array, since there may be more than one “Value” triple within the triplestore. The {“IsA”, “Property”} component may also assure that the value corresponds to a property; similarly, another triple may then indicate that the subject (e.g., User5_Property_4) may be a Property (e.g., such as <User5_Property_4 IsA Property>).

Additionally, in an embodiment, for each variable in a program, such as a program implementing SPARQL language, at least one triple connecting that variable to the agent may be added to the triplestore, via the collaborative intelligent agent system and/or methods thereof, forming a connection between the triples and/or programs that run on the triples. For example, in some embodiments, if an agent called LoanAgent includes CreditScore as one of its inputs, then the triple <CreditScore IsInputTo LoanAgent> may be added to the triplestore. In this manner, implementing the SPARQL language, such as by searching “Search <CreditScore IsInputTo?→LoanAgent”, may return a list of agents having CreditScore as an input, allowing for optimal search for agents to a specific triple of the plurality of triples.

In an embodiment, the collaborative intelligent agent system and/or methods thereof may also include at least one maximally inferred triplestore, such that every time a new triple is added, the collaborative intelligent agent system may be configured to find and/or execute each program that may include the triple as an input. In addition, any triple that may be produced by the execution of a program may then be automatically added to the triplestore in the same manner, in real-time, such that the execution of all programs having that triple as an input may be induced. As such, in this embodiment, this cascading effect may propagate all new inputs, such that the intelligent agents may collaborate in determining outputs. Additionally, in this embodiment, the propagation of the collaborative intelligent agent system may run in optimal time since the inputs and/or outputs may each be machine-readable and/or collaborative in nature. In this manner, a run time may be proportional to O(log n) per program match, where n may represent the number of triples in the triplestore. The inference engine that is part of the triplestore may then use the added connectors in its induction process to connect the triples to the corresponding programs. Accordingly, each agent may search (e.g., or may attempt to search, if no match is found) for all other inputs needed for execution in the same optimal time, O(log n) per input variable.

Furthermore, in an embodiment, the language used for the agents may also provide for the specification of an input's relative location within a knowledge graph. Moreover, in this embodiment, the meaning of at least one triple of the plurality of triples may depend on its relative location within the knowledge graph, including but not limited to the context from the location. For example, in some embodiments, for the input specifier (double interest [j] {“Mortgage”}, “InterestRate”), the variable “interest” may represent an array of type “double” with “j” components. The index “j” may also represent also a variable, such that the index “j” may be assigned to the number of “InterestRate” triples found when searching the inputs prior to execution. As such, in these other embodiments, the “interest” variable may also be linked to the “InterestRate” predicate. Accordingly, the collaborative intelligent agent system and/or methods thereof may then consider the outbound edge “Mortgage” within the knowledge graph prior to searching for the “InterestRate” triples. In addition, in an embodiment, the collaborative intelligent agent system and/or methods thereof may include a validation specifier as an input: (e.g., double interest [j] “Value” {“IsA”, “Property”}). As such, in these other embodiments, for the input to be valid and/or executed, knowledge may be required within the knowledge graph to indicate that the value corresponds to a component that “Is A” “Property”.

The following example(s) is (are) provided for the purpose of exemplification and is (are) not intended to be limiting.

### EXAMPLES

### Example #1

### Inducing Outputs Via Intelligent Agents

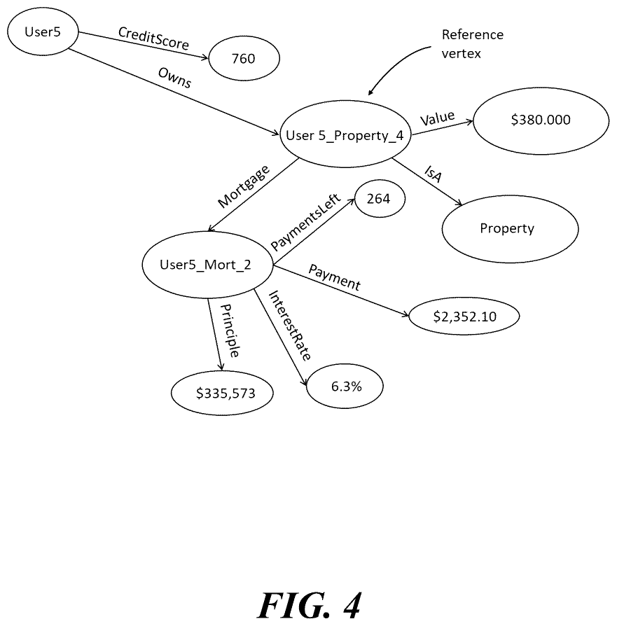

An example of an automated and dynamic collaborative intelligent agent system and/or methods thereof for inducing outputs via intelligent agents is outlined in the knowledge graph shown in FIG. 4. In the example, a triple added to the triplestore induces the execution of the agent BankOneLoanAgent, and later induces the agent CongratulationsAgent. The collaborative nature of the system is such that the output triples produced and added by the execution of BankOneLoanAgent induces the execution of CongratulationsAgent, when then produces and adds its own output triples.

An intelligent agent is designed to generate loan offers to users, providing targeted offers to specific qualified users instead of blind offers to a broader population, with the intelligent agent including the following instructions:

sequentialblock BankOneLoanAgent
{
input:

| | |
|---|---|
| double value[i], | “Value” {“IsA”,“Property”}; |
| double interest[j] {“Mortgage”}, | “InterestRate”; |
| double principle[k] {“Mortgage”}, | “Principle”; |
| int paymentsleft[l] {“Mortgage”}, | “PaymentsLeft”; |

```
  int credit {“-Owns”}, “CreditScore”;
output:
  string bank[k] {“-Owns”}, “LoanProposal”;
body:
  bank[0] = “Bank One”;
  iy = .015;
  P = principle[0] + 5000;
  n = paymentsleft[0];
  i = iy / 12;
  x = (i+1)\hat{ }n;
  A = ( (i*x) / (x−1) ) * P;
  AddOutputAttribute(bank,0,“InterestRate ”,iy);
  AddOutputAttribute(bank,0,“Principle”,P);
  AddOutputAttribute(bank,0,“PaymentsLeft”,n);
  AddOutputAttribute(bank,0,“Payment”,A);
}
```

Upon receiving an update of the “Value” input from $380,000 to $430,000 (defined by the triple <User5_Property_4 Value $430,000>), the collaborative intelligent agent system and/or methods thereof search for all agents having “Value” as one of its inputs. Finding BankOneLoanAgent, the system verifies the validity of the “Value” triple, searching for <User5_Property_4 IsA Property>. Finding that the triple exists, the system searches for the “interest” input, searching for the subject of the mortgage portion of the knowledge graph and finding User5_Mort_2 as the subject: <User5_Property_4 Mortgage???→User5_Mort_2.

Next, the system searches for the input triple “Interest,”<User5_Mort_2 InterestRate??? →6.3, and identifies the remaining inputs in the same manner: <User5_Mort_2 Principle???→$335,573; <User5_Mort_2 PaymentsLeft???→264; and <User5_Mort_2 InterestRate???→6.3.

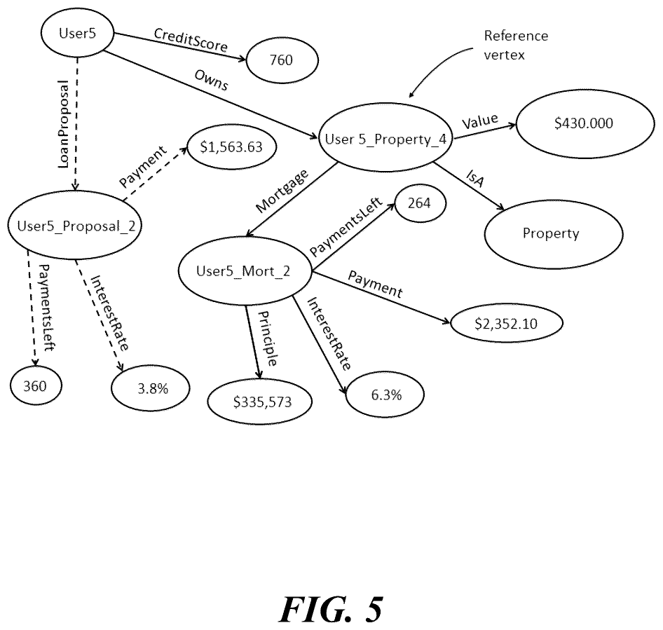

Searching for the credit input, the input specifies that the system must search backward along the “Owns” edge to obtain the subject representing the user. The system therefore searching for the subject <??? Owns User5_Property_4>→User5, and subsequently searches for the input <User5 CreditScore???>→760. Having identified all of the inputs, the collaborative intelligent agent system and/or methods thereof execute the agent. The execution of the agent in turn produces and adds the following output triples: <User5 LoanProposal User5_Proposal_2>; <User5_Proposal_2 InterestRate 0.015>; <User5_Proposal_2 Principle 83560>; <User5_Proposal_2 PaymentsLeft 30>; and <User5_Proposal_2 Payment $1,500>. The resulting knowledge graph is shown in FIG. 5.

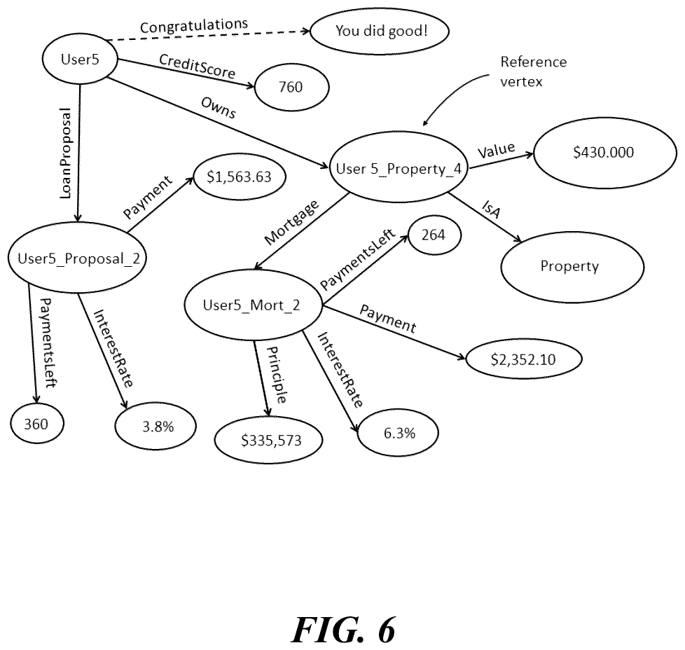

Turning to FIG. 6, an embodiment of the collaborative intelligent agent system and/or methods thereof includes the inducement of a second intelligent agent given an execution of a first intelligent agent. The second intelligent agent includes the following instructions:

| sequentialblock CongratulationAgent | |
|---|---|
| { | |
| input: | |
| string bank[i], | “LoanProposal”; |
| output: | |
| string note[i], | “Congratulations”; |

```
  body:
    note[0] = “You did good!”;
}
```

When the LoanProposal triple was added to the account for User5, the LoanProposal triple collaboratively and independently induced the CongratulationsAgent agent, which executed and produced the triple <User5 Congratulations “You did good!”>. Since there are no subsequent agents that include Value, LoanProposal, or Congratulations as an input, the process stops, and the system awaits a new triple to run again.

In the event that multiple triples include the same vocabulary or predicate (such as two mortgages on a property or two owners for a property), inputs can be grouped by their relative location within a knowledge graph using a group keyword (such as group firstmort[m], with a variable having an array of structures, such as firstmort[2]. interest[3]). The previous example indicates the third interest triple found in the second mortgage group, with a total of m mortgage groups, with i InterestRate and p Principle triples for each mortgage. In addition, there may be different types of the same variable (such as mortgages), with an example of the instructions as follows:

| | |
|---|---|
| group firstmort[m1] | “FG:Mortgage”, |
| | {“FG:IsA”,“FG:FirstMortgage”} |

{

| | |
|---|---|
| double interest[i1] | “FG:InterestRate”; |
| double principle[p1] | “FG:Principle”; |

};

| | |
|---|---|
| group secondmort[m2] | “FG:Mortgage”, {“FG:IsA”,“FG:EquityLine”} |

{

| | |
|---|---|
| double interest[i2] | “FG:InterestRate”; |
| double principle[p2] | “FG:Principle”; |

};

Given the instructions in the example above, with firstmort[2].interest[3], the instruction represents the third interest triple found in the second mortgage group, with the mortgage being a first or primary mortgage, not an equity line.

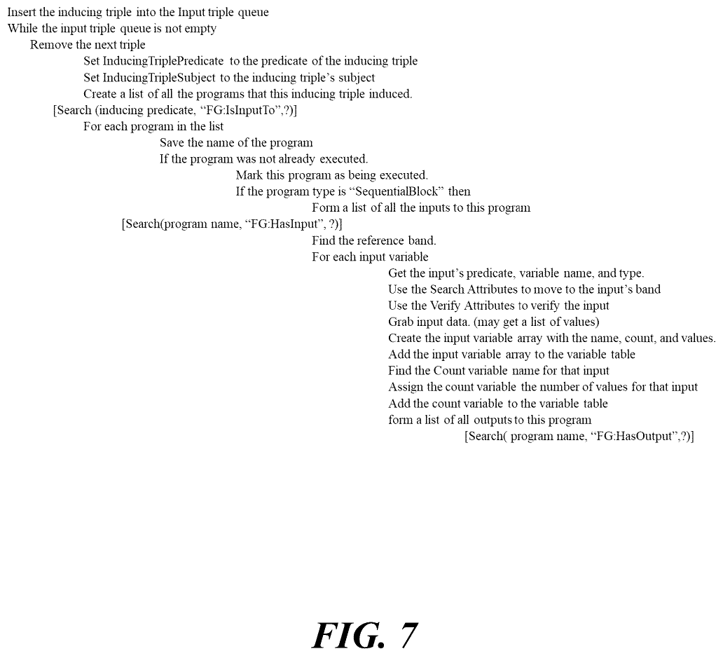

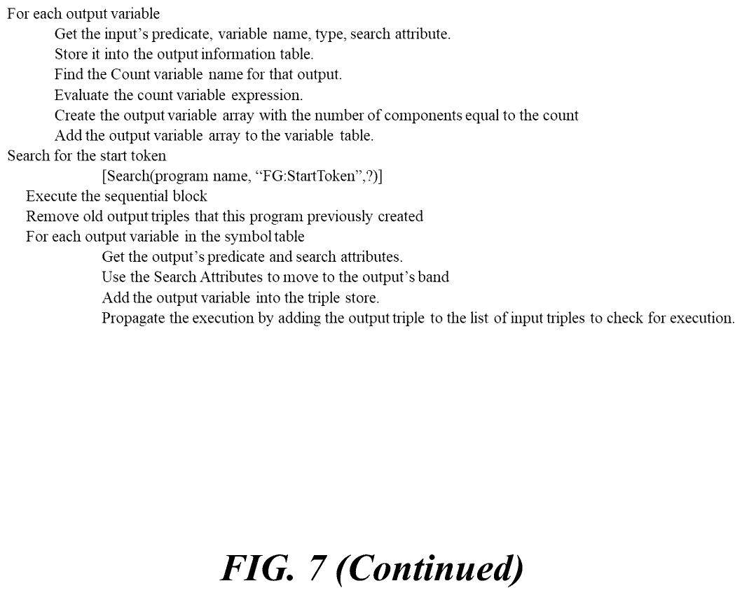

An embodiment of the execution algorithm used in combination with the process and method is shown in greater detail in FIG. 7.

The advantages set forth above, and those made apparent from the foregoing description, are efficiently attained. Since certain changes may be made in the above construction without departing from the scope of the invention, it is intended that all matters contained in the foregoing description or shown in the accompanying drawings shall be interpreted as illustrative and not in a limiting sense.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

It is also to be understood that the following claims are intended to cover all of the generic and specific features of the invention herein described, and all statements of the scope of the invention which, as a matter of language, might be said to fall therebetween.

What is claimed is:

1. A method of automatically, dynamically, or both inducing outputs via a plurality of intelligent agents, the method comprising the steps of:
searching, via a first intelligent agent, a first set of prerequisite thresholds for a match of an updated data point;
based on a determination of the match of the updated data point, executing the first intelligent agent to produce a first output;
searching, via a second intelligent agent, a second set of prerequisite thresholds for a match of the first output received from the first intelligent agent, a match of at least one alternative output received from at least one alternative intelligent agent, or both; and
based on a determination of the match of the first output, the match of the at least one alternative output, or both, inducing an execution of the second intelligent agent to produce a second output.

2. The method of claim 1, wherein the first intelligent agent has an output that is an input for the second intelligent agent.

3. The method of claim 2, wherein the first and second intelligent agents are independent from each other, whereby each of the first and second intelligent agents include a set of prerequisite thresholds.

4. The method of claim 1, further comprising the step of, translating an amount of data into a machine-readable format.

5. The method of claim 4, further comprising the step of, compiling the machine-readable data, generating relationships between subjects, predicates, and objects of the machine-readable data, or both.

6. The method of claim 5, further comprising the step of, generating the first intelligent agent and the second intelligent agent.

7. The method of claim 6, further comprising the step of, receiving an input of the updated data point.

8. The method of claim 7, further comprising the step of, preserving, via a token system communicatively coupled to the first intelligent agent, the second intelligent agent, or both, an order of the first intelligent agent, the second intelligent agent, or both and an order between the first output and the second output.

9. The method of claim 8, wherein the step of preserving the order of the first intelligent agent, the second intelligent agent, or both and the order between the first output and the second output further comprises the step of, generating, via the token system, an input token, an output token, or both, whereby the input token, the output token, or both are analogous to labels representing an instruction address.

10. The method of claim 9, wherein when the input token is available, the output token indicates a next output to execute.

11. The method of claim 4, further comprising the step of interlinking at least one of a plurality of triples with the first intelligent agent, the second intelligent agent, or both, wherein at least one of the plurality of triples is considered a variable, whereby when at least one additional triple of the plurality of triples is interlinked with the first intelligent agent, the second intelligent agent, or both, the first intelligent agent, the second intelligent agent, or both is configured to execute at least one of a plurality of programs that include at least one triple of the plurality of tiples as an input.

12. The method of claim 11, wherein the execution of at least one of the plurality of programs that include at least one triple of the plurality of triples comprises a run time proportional to O(log (n)) per program match, whereby the first intelligent agent, the second intelligent agent, or both is configured to search for any additional executable programs at the same optimal time of O(log (n)).

13. An automatic, dynamic, or both system for inducing outputs via intelligent agents, the system comprising:
at least one processor; and
a non-transitory computer-readable medium operably coupled to the processor, the computer-readable medium having computer-readable instructions stored thereon that, when executed by the at least one processor, cause the automatic, dynamic, or both system to induce outputs via a plurality of intelligent agents by executing instructions comprising:
searching, via a first intelligent agent, a first set of prerequisite thresholds for a match of an updated data point;
based on a determination of the match of the updated data point, executing the first intelligent agent to produce a first output;
searching, via a second intelligent agent, a second set of prerequisite thresholds for a match of the first output received from the first intelligent agent, a match of at least one alternative output received from at least one alternative intelligent agent, or both; and
based on a determination of the match of the first output, the match of the alternative output, or both, inducing an execution of the second intelligent agent to produce a second output.

14. The system of claim 13, wherein the executable instructions further comprise the step of, translating an amount of data into a machine-readable format.

15. The system of claim 14, wherein the executable instructions further comprise the step of, compiling the machine-readable data, generating relationships between subjects, predicates, and objects of the machine-readable data, or both.

16. The system of claim 15, wherein the executable instructions further comprise the step of, generating the first intelligent agent and the second intelligent agent.

17. The system of claim 16, wherein the executable instructions further comprise the step of, receiving an input of the updated data point.

18. The system of claim 17, wherein the executable instructions further comprise the step of, preserving, via a token system communicatively coupled to the first intelligent agent, the second intelligent agent, or both, an order between the first output and the second output.

19. The system of claim 18, wherein the step of preserving the order between the first output and the second output of the executable instructions further comprises the step of, generating, via the token system, an input token, an output token, or both, whereby the input token, the output token, or both are analogous to labels representing an instruction address.

20. The system of claim 19, wherein when the input token is available, the output token indicates a next output to execute.
